(19) United States
(12) Patent Application Publication
(10) Pub. No.: US 2003/0198128 A1
(43) Pub. Date: Oct. 23, 2003

(54) Mixing system having non-contacting bearings

(76) Inventor: Roger W. Carlson, Oak Leaf, TX (US)

Correspondence Address: Michael L. Diaz, Michael L. Diaz, P.C., 555 Republic Drive, Suite 200, Plano, TX, 75074, US

(21) Appl. No.: 10/126,599

(22) Filed: Apr. 19, 2002

(51) Int. Cl. B01F 7/00

(52) U.S. Cl. 366/331

(57) ABSTRACT

A seal-less immersible mixing system for agitating materials contained within a storage tank. The mixing system utilizes an induction motor to drive a drive shaft having an impeller. The mixing system also includes a plurality of magnetic non-contact bearings circumferentially located around a portion of the drive shaft. The magnetic bearings reduce periodic service requirements typically required of existing mixing systems using contact bearings. Elimination of mechanical seals further reduces periodic service requirements of existing mixing systems utilizing mechanical seals.

### BACKGROUND OF THE INVENTION

1. Technical Field of the Invention This invention relates to tank mixers, and more particularly, to an immersible tank mixer utilizing non-contact bearings.

2. Description of Related Art

Mixing systems are commonly used to agitate, mix, and circulate materials, such as liquid suspensions and liquids. In the petroleum industries, liquid petroleum products are stored within large storage tanks. The petroleum products include several substances which must be mixed within the liquid material to provide uniform composition to the products. A mixing system is used in order to provide uniform composition within the storage tanks.

However, positioning mixing systems within the storage tank creates several problems. First, the mixing system is constantly subjected to aggressive materials which can damage the mixing system. Additionally, existing mixing systems typically use seals to prevent leakage within the mixing system/storage tank combination. Existing mixing systems also utilize direct contact bearings and gears to rotate drive shafts driving mixing devices. The bearings and gears wear out over a period of time. In particular, the bearings commonly require replacement after approximately eight years. In order to service and replace bearings and gear components of the mixing system, the storage tank must be drained. Thus, the storage tank is removed from service, oftentimes for several days, which results in the loss of significant amounts of money. When one considers the amount of tanks located worldwide utilizing existing mixing systems, the cost of servicing storage tanks is simply staggering. Additionally, governmental environmental agencies have stringent rules regarding leakage of substances from the storage tanks. It is quite common for owners of the storage tanks to be levied hefty fines for any leaks or faulty maintenance procedures.

Although there are no known prior art teachings of an apparatus or system such as that disclosed herein, prior art references that discuss subject matter that bears some relation to matters discussed herein are U.S. Pat. No. 5,368,390 to Gambrill et al. (Gambrill I), U.S. Pat. No. 5,478,149 to Quigg (Quigg), U.S. Pat. No. 5,542,762 to Nakanishi et al. (Nakanishi), U.S. Pat. No. 5,779,359 to Gambrill et al. (Gambrill II), and U.S. Pat. No. 6,206,562 to Eyraud et al. (Eyraud).

Gambrill I discloses a mixer system for aggressive materials which are mixed in a tank with an impeller connected to a drive shaft having the impeller and its shaft mounted in an assembly which extends through an opening into the tank and closes that opening. The assembly also includes a cylindrical hub with a passageway through which the shaft extends out of an open end of the hub. Bearings are made of materials which are resistant to the aggressive material in the tank and are mounted in the hub and journal to support the shaft. There are no dynamic seals which close the confinement region. However, Gambrill I does not disclose the use of non-contact bearings. Gambrill I suffers from the disadvantage of using contact bearings which must be periodically replaced.

Quigg discloses a magnetic mixer having an agitator that includes a plurality of agitator magnets. The mixer also includes a bearing arrangement which allows the agitator to be magnetically levitated along the outer surface of a cylindrical vessel fitting locating within a mixing vessel. The same magnetic force that is used to levitate the mixer drives the agitator. The magnetic force is generated by a plurality of magnets which rotate within an aperture extending into the vessel fitting. By magnetically levitating the agitator, no thrust is generated by the agitator and thus eliminates the requirement for thrust bearings. However, Quigg does not teach or suggest centering the shaft within a casing. Quigg merely discloses levitating the agitator around an outer surface of a cylindrical vessel.

Nakanishi discloses an agitator having a multi-freedom electric motor. The electric motor includes a spherical rotor, a plurality of magnets disposed on an outer surface of the rotor with polarities of the respective adjacent magnetic poles being different from one another. The motor also includes a stator located along the outer surface of the rotator and a plurality of magnets opposed to the magnets disposed on an inner surface of the stator. The rotor is supported by a spherical bearing positioned on the stator. However, Nakanishi also does not teach or suggest non-contact bearings to support a drive shaft for driving an impeller. Nakanishi suffers from the disadvantage of requiring periodic maintenance induced by wear and tear on the bearings.

Gambrill II discloses an immersible magnetically-coupled mixer having a plurality of rolling element bearing assemblies readily cleanable by flushing in place and easily removable and replaceable without damage to either the mixer impeller or the bearings. The rollable bearings are resistant to corrosion and capable of running without lubrication. The impeller contains magnets and is connected to an external magnetic mixer drive. The bearings are exposed to the liquid in the vessel during agitation. However, Gambrill II does not teach or suggest non-contact bearings. As with existing mixing systems, Gambrill II utilizes bearings which are susceptible to damage and wearing.

Eyraud discloses a magnetically driven agitator having a member adapted for mounting through a wall of a receptacle and which has a sleeve which is housed in a rotor for supporting a first magnetic coupling structure. A propelling screw is positioned around the sleeve and supports a second magnetic coupling structure which cooperates with the first magnetic coupling structure in order to rotate the screw about an axis of rotation. The rotor is moveable parallel to the axis of rotation inside the sleeve between a first position where the first and second coupling structures are generally opposite. However, Eyraud does not teach or suggest the use of non-contact bearings for supporting the shaft.

Eyraud merely discloses conventional bearings requiring periodic replacement.

Review of the foregoing references reveals no disclosure or suggestion of a mixing system employing non-contact bearings for supporting a shaft within an enclosure and a linearly mounted induction motor which does not require the use of conventional gears. It is an object of the present invention to provide such an apparatus and system.

### SUMMARY OF THE INVENTION

In one aspect, the present invention is a mixing system for agitating materials contained in a storage container. The mixing system includes a drive shaft having an impeller, a casing covering a portion of a length of the drive shaft, and a plurality of non-contact bearings circumferentially located around a portion of the drive shaft within the casing. The plurality of non-contact bearings support the drive shaft within the casing. In addition, the drive shaft is rotated by an induction motor coupled to the drive shaft. Rotation of the drive shaft causes movement of the impeller for agitating materials contained in the storage container.

In another aspect, the present invention is a mixing system for agitating materials. The mixing system includes a storage container holding a liquid in an interior portion of the storage container and a drive shaft having an impeller. The drive shaft is positioned within the interior portion of the storage container. Additionally, the mixing system includes a casing covering a portion of a length of the drive shaft and a plurality of non-contact bearings located around a portion of the drive shaft within the casing. The plurality of non-contact bearings maintain the position of the drive shaft within the casing. The drive shaft is rotated by a motor. With the rotation of the drive shaft, the impeller moves through the materials contained with the storage container, causing agitation of the material.

In still another aspect, the present invention is a mixing system for agitating materials. The mixing system includes a storage container holding a liquid in an interior portion of the storage container and a drive shaft having an impeller. The drive shaft is positioned within the interior portion of the storage container. The mixing system also includes a casing covering a portion of a length of the drive shaft and a plurality of non-contact magnetic bearings circumferentially located around a portion of the drive shaft within the casing. The plurality of non-contact bearings position the drive shaft within the casing. In addition, the mixing system includes an induction motor having a rotor and induction coils surrounding a portion of the drive shaft for rotating the drive shaft. Rotation of the drive shaft causes the impeller to agitate the liquid held in the interior portion of the storage container.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is an elevational view partially in cross-section of an existing mixer;

FIG. 2 is an elevational view partially in cross-section of a mixing system in the preferred embodiment of the present invention; and

FIG. 3 is an enlarged elevational view of the interior of the containment shell of FIG. 2.

### DETAILED DESCRIPTION OF EMBODIMENTS

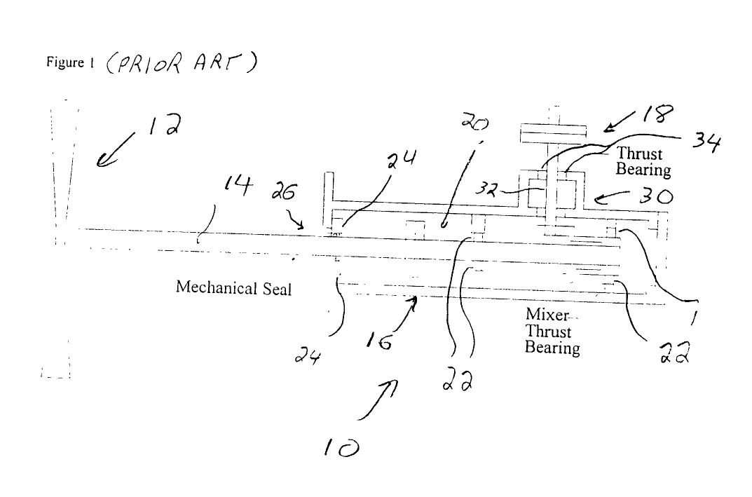

An immersible mixing system utilizing non-contact bearings is disclosed. FIG. 1 is an elevational view partially in cross-section of an existing mixer 10. The existing mixer includes an impeller 12 attached to a drive shaft 14. A portion of the drive shaft is positioned within a casing 16. The drive shaft is driven by a perpendicularly-aligned motor As illustrated in FIG. 1, the casing 16 is typically a cylindrically shaped container for holding a portion of the drive shaft 14. The drive shaft is suspended within an interior portion 20 of the casing by a plurality of thrust bearings 22. The bearings are conventional bearings which contact the drive shaft. Additionally, mechanical seals 24 are set at an exit area 26 where the drive shaft extends out of the interior of the casing. The mechanical seals may be dynamic or static shaft seals.

The drive shaft 14 is driven by the motor 18 through a gearing system 30. The motor 18 rotates a drive train 32, which is perpendicular to the drive shaft. As is common with many drive systems, the gearing system translates the rotation of the drive train for rotation of another component in a different axis, in this example to the horizontal axis of the drive shaft. The drive train is positioned and allowed to rotate through the assistance of a plurality of bearings 22 and 34.

The existing mixer 10 is typically mounted on a storage tank (not shown) or container holding liquids. The mixer is used for suspending, agitating and/or circulating materials within the storage tank. Normally, the material being mixed includes aggressive materials such as substances having toxic, hazardous, corrosive, or environmentally damaging properties or other substances which must be confined to an enclosure.

In operation, the mixer 10 is positioned within the interior of the storage tank. The storage tank is filled with a material. The material requires mixing, which is accomplished by the mixer. The motor 18 rotates the drive train 32, which in turn, through the gearing system 30 rotates the drive shaft 14. By rotating the drive shaft, the impeller is rotated. The movement of the impeller agitates or mixes the material located within the storage tank.

The mixer includes several parts which are subjected to continual frictional forces. Due to the physical contact between such components as the radial and thrust bearings 22 and 34, drive shaft 14, gearing system 30 and mechanical seals, periodic replacement of these components is necessary. However, in order to replace the worn components, the storage tank must be drained. The mixer is then serviced, typically taking several days to complete. During this down time, significant losses in revenue are seen.

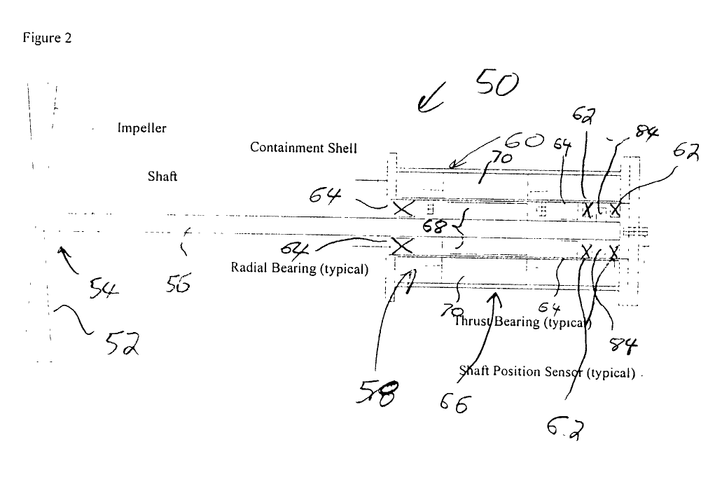

FIG. 2 is an elevational view partially in cross-section of a mixing system 50 in the preferred embodiment of the present invention. The mixing system includes an impeller 52 attached to an end 54 of a drive shaft 56. A portion of the drive shaft is positioned within an interior portion 58 of a containment shell 60.

The drive shaft 56 is suspended within the interior portion 58 of the containment shell 60 by a plurality of magnets and magnetic bearings. The mixing system includes thrust bearing magnets 62 and magnetic radial bearings 64 circumferentially arranged around a portion of the drive shaft. The drive shaft is rotated by an induction motor 66. The induction motor includes a rotor 68 and coils 70.

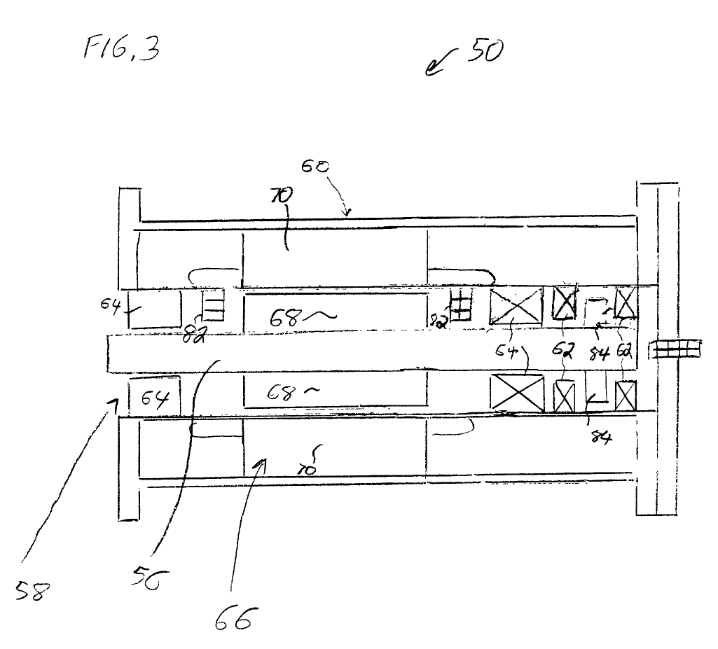

FIG. 3 is an enlarged elevational view of the interior of the containment shell 60 of FIG. 2. The mixing system also includes an axial proximity probe 80, radial probes 82, and a thrust disk 84. The shaft position sensor senses the position of the drive shaft in relation to the containment shell 60. This information is sent to a magnetic bearing control box (not shown) which then adjusts the magnetic bearings 62 and 64 to maintain the drive shaft 56 in the desired position relative to the containment shell 60. The thrust disk is securely attached to the drive shaft 56 to transmit axial locating forces from the thrust bearings 62 to the drive shaft 56. Unlike existing bearing components, the magnetic bearings may operate without the presence of liquid flowing between the bearing surfaces. Existing contact bearings require that the bearings be immersed within a liquid or the bearings will fail. The interior components of the mixing system may be coated with a material impervious to damage from the aggressive materials being mixed within the storage tank.

Referring to FIGS. 2 and 3, the operation of the mixing system 50 will now be explained. The mixing system, in a similar manner to the mixer 10, penetrates the storage tank (not shown) containing a material requiring mixing of the substances comprising the material. Since the substances of the material being mixed may include aggressive materials, containment of the material within a closed system is required. Thus, in the preferred embodiment of the present invention, the entire mixing system is placed within the interior of the storage tank. The induction motor is used to rotate the drive shaft 56. The induction motor, since it is attached to the drive shaft, does not require a gearing mechanism.

Additionally, the drive shaft does not contact any bearings, rather relying on the magnetic bearings to suspend the drive shaft. The drive shaft is thus rotated about its axis to move the impeller 52. Movement of the impeller 52 allows the substances contained within the storage tank to be mixed, agitated, suspended, or circulated as desired. As discussed above, the drive shaft is suspended within the interior of the containment shell in such a manner that the drive shaft is not contacting any component of the mixing system. Thus, wearing of the bearings or the replacement of any gear mechanism is completely eliminated, which reduces the downtime necessitated by servicing of the mixing system 50.

Although the mixing system 50 is particularly effective in mixing petroleum products stored within storage tanks, the mixing system 50 may be used for any material requiring mixing, circulating, suspending or agitating of its substances. For example, the mixing system may be used within the pharmaceutical and food processing industry, both of which demand non-contamination of its stored product. Additionally, any type of tank, vessel or container where liquids are mixed or otherwise agitated may employ the mixing system 50. It should be understood that the impeller may be configured in any size and shape allowing agitation of the substances to be mixed.

The mixing system 50 provides many advantages over existing mixers. Unlike existing mixing systems, the mixing system 50 does not include contact bearings. Since no contact bearings are utilized, periodic maintenance of the mixing system is reduced considerably. Additionally, since a gearing system is not required by the power plant, the mixing system is again simplified to reduce maintenance down time. Also, the mixing system 50 does not utilize a mechanical seal to isolate the storage tank material from the environment. Eliminating the mechanical seal removes the most frequent failure mechanism and greatest environmental safety risks of conventional mixing systems.

It is thus believed that the operation and construction of the present invention will be apparent from the foregoing description. While the apparatus and system shown and described has been characterized as being preferred, it will be readily apparent that various changes and modifications could be made therein without departing from the scope of the invention as defined in the following claims.

What is claimed is:

1. A mixing system for agitating materials contained in a storage container, the mixing system comprising:
a drive shaft having an impeller;
a casing covering a portion of a length of said drive shaft;
a plurality of non-contact bearings circumferentially located around a portion of said drive shaft within said casing, said plurality of non-contact bearings supporting said drive shaft within said casing; and
means for rotating said drive shaft, rotation of said drive shaft causing movement of the impeller for agitating materials contained in the storage container.

2. The mixing system for agitating materials of claim 1 wherein the means for rotating said drive shaft is an induction motor.

3. The mixing system for agitating materials of claim 2 wherein the induction motor includes a rotor and induction coils surrounding a portion of said drive shaft.

4. The mixing system for agitating materials of claim 1 wherein the plurality of non-contact bearings are magnetic bearings.

5. The mixing system for agitating materials of claim 1 wherein said drive shaft, said plurality of non-contact bearings, and the impeller are coated with a substance impervious to the materials being agitated.

6. The mixing system for agitating materials of claim 1 wherein said mixing system is immersed within the materials being agitated.

7. A mixing system for agitating materials, the mixing system comprising:
a storage container holding a liquid in an interior portion of said storage container;
a drive shaft having an agitating means, said drive shaft being positioned within the interior portion of said storage container;
a casing covering a portion of a length of said drive shaft;
a plurality of non-contact bearings located around a portion of said drive shaft within said casing, said plurality of non-contact bearings aligning said drive shaft within said casing; and
means for rotating said drive shaft, rotation of said drive shaft causing the agitating means to agitate the liquid held in the interior portion of said storage container.

8. The mixing system for agitating materials of claim 7 wherein said agitating means is an impeller.

9. The mixing system for agitating materials of claim 7 wherein the means for rotating said drive shaft is an induction motor.

10. The mixing system for agitating materials of claim 9 wherein the induction motor includes a rotor and induction coils surround a portion of said drive shaft.

11. The mixing system for agitating materials of claim 7 wherein the plurality of non-contact bearings are magnetic bearings.

12. A mixing system for agitating materials, the mixing system comprising:
a storage container holding a liquid in an interior portion of said storage container;
a drive shaft having an impeller, said drive shaft being positioned within the interior portion of said storage container;
a casing covering a portion of a length of said drive shaft;
a plurality of non-contact magnetic bearings circumferentially located around a portion of said drive shaft within said casing, said plurality of non-contact bearings positioning said drive shaft within said casing; and
an induction motor having a rotor and induction coils surrounding a portion of said drive shaft for rotating said drive shaft, rotation of said drive shaft causing the impeller to agitate the liquid held in the interior portion of said storage container.
